(19) United States
(12) Patent Application Publication
(10) Pub. No.: US 2008/0264971 A1
(43) Pub. Date: Oct. 30, 2008

(54) Dispensing Device

(76) Inventors: Manfred Harre, Landsberg am Lech (DE); Ingo W. Wagner, Worthsee (DE); Dirk Muller-Paul, Munchen (DE)

Correspondence Address: 3M INNOVATIVE PROPERTIES COMPANY, PO BOX 33427, ST. PAUL, MN, 55133-3427, US

(21) Appl. No.: 11/815,822

(22) PCT Filed: Mar. 10, 2006
(86) PCT No.: PCT/EP2006/002229

§ 371 Date: Aug. 8, 2007

(30) Foreign Application Priority Data
Mar. 11, 2005 (EP) 05005367.7

(51) Int. Cl. B67D 5/52; B67D 5/42

(52) U.S. Cl. 222/137; 222/392

(57) ABSTRACT

The present invention is related to a devices, systems and methods for dispensing multiple-component flowable dental substances. In particular, the present invention is directed to device for dispensing at least one flowable dental substance, comprising at least one force transmitting member adapted to a) transmit a pushing force in a direction toward or opposite the substance and b) be gathered non-linearly. In particular, the present invention is directed to dispensing materials such as multiple-component dental materials used for making dental impressions.

### TECHNICAL FIELD

The present invention is related to a device, method and system for dispensing multiple-component flowable dental materials. In particular, the present invention is directed to dispensing multiple-component dental impression materials used for making models of teeth.

### BACKGROUND OF THE INVENTION

Devices for dispensing single- and multiple-component flowable substances are well known in the art.

For instance, there are several hand-held dispensing devices known in the art designed for dispensing flowable construction materials, such as caulk, adhesives and the like. For example, DE 34 37 306 describes a motorized single component hand-held device for dispensing construction material such as sealant, adhesive or putty. The device comprises an area for receiving a cartridge filled with the construction material and a driving member for pushing the material forward out of the front end of the cartridge. Instead of using a rigid piston as driving member as commonly used in such dispensing devices, the device of DE 34 37 306 uses a telescopic spindle having a rigid piston rod attached to its front end, in order to minimize the storage area necessary for the driving member when fully retracted. The telescopic spindle is adapted to slide forward and backward in overlapping sections along the longitudinal axis of the material cartridge. The forward and backward movement of the spindle is actuated by a worm gear arrangement. In order to hinder rotation of the overlapping sections of the spindle as the spindle is retracted, a guide wire is provided, in part, within the interior of the spindle. The guide wire is attached to the front section of the spindle and is adapted to securely pull the front section away from the substance thereby hindering the spindle from rotating.

EP 0 128 364 also describes a hand-held device for dispensing single component sealing pastes. The device also comprises an area for receiving a cartridge filled with the construction material and a driving member for driving the construction material forward out of the device. In EP 0 128 364, the driving member is a coil or helical spring attached to a piston rod and the elastic force of the spring is used in part to drive the construction material forward. In one embodiment of the device of EP 0 128 364, two bands windable around respective winches are used to assist in the forward and backward movement of the spring. One band is associated with the piston rod attached to the rear end of the spring. This band provides forward movement of the spring by pulling the rear end of the piston rod. The other band is associated with the front end of the spring. This band provides backward movement of the spring by pulling the front end of the spring.

U.S. Pat. No. 6,321,945 B1 discloses a hand-held motor driven dispenser for dispensing caulking and glue material. As driving member, the dispenser uses a collapsible push rod having a head that abuts a canister containing material in such a manner that forward movement of the push rod applies a pushing force onto the canister to drive the material forward. The collapsible push rod is formed of a plurality of discrete blocks such that it can be guided into a generally U-shaped configuration by using guiding gears and a guiding track mounted on the inner surface of the top wall of the dispenser. In addition to the guiding gears, the dispenser has a plurality of drive gears mechanically coupled to the motor and in communication with teeth on the bottom surface of the push rod such that movement of the drive gears causes movement of the push rod.

WO 03/064056 describes a caulking gun having a self-contained drive mechanism to forwardly advance a push rod chain arrangement comprising two interlocking chains, each composed of a series of individual links connected in pivotable fashion to one another. The shape of the individual links enables the two chains to be interlocked as one parallel chain arrangement forming a push-rod to compress the caulk cartridge for extrusion of the material contained therein.

DE 30 31 939 A1 also describes a hand-held dispenser for dispensing flowable construction materials. The dispenser comprises a bendable pushing rod, in the form of a tension spring attached to a plunger at one end, for pressing the material forward out of the dispenser. A guide channel is provided for containing the tension spring and for preventing the spring from buckling.

As described, the above dispensers primarily serve as single component dispensers for dispensing materials such as caulk, adhesive and the like.

Multiple-component dispensers for both mixing and dispensing are also known in the art. Such multi-component dispensers are desirable, particularly in cases where components of a material should be mixed just prior to use. In such dispensers, the material components are generally stored in separate material chambers and displaced simultaneously toward a mixer by pistons or plungers which are advanced within the material chambers along their length by separate driving members. At least in this respect, the drive mechanisms for the multi-component dispensers are different from those of the single component dispensers. With multi-component dispensers, an assembly is generally provided to ensure simultaneous movement of the driving members especially when the mixing ratio of the material components is different from 1:1. For example, components for dental impression materials are often mixed at a ratio of 1:2 (or, in some cases 1:5). Due to such mixing ratios, it may be difficult to advance driving members synchronously or at an exact advancing ratio relative to each other. In many multi-component dispensers, the driving members are moved synchronously, by using one drive, e.g. one motor, to drive several driving members. In such dispensers the material chambers have the same length but different cross-sectional areas if the mixing ratio is different from 1:1. As a result the individual driving members have to be adapted to provide different forces for synchronously pushing the pistons forward in the material chambers. For example, for a 1:5 composition, the ratio of the forces required for pushing the pistons would be 1:25, assuming equal pressure in both chambers during displacement of the components. Additionally, the material component forming the major part of the mixed material often contains fillers (e.g. quartz) making it more viscous relative to the other material component, which increases the difference of the forces and shifts the ratio of forces beyond 1:25. This difference in the viscosities of the individual material components also influences the necessary pushing forces. Overall, this means that the load is different on each of the driving members during expelling of the components. In order to achieve an exact mixing ratio of the material components, the driving members have to be guided in a manner to ensure synchronous advancement. As can be seen from U.S. Pat. No. 5,064,098 and EP-A-0 492 413, this is usually done by connecting the driving members to each other by a stiff cross bar and guiding this whole assembly with a strong linear bearing so as to avoid tilting.

U.S. Pat. No. 5,064,098 describes a dual component dispenser gun for mixing and dispensing flowable dual component materials, such as adhesives, sealants and the like. The dispenser gun is designed for use with a cartridge having two barrels respectively filled with two flowable components, in combination with a mixing nozzle through which the components can be mixed and dispensed. The cartridge is supported on top of a main pressure cylinder adapted for controlled connection to a pressurized fluid source, such as compressed air, for displacing a power piston in a first direction. The power piston is connected to a pair of flexible piston rods which extend through curved guide channels in a guide head and are connected in turn to a pair of flexible piston rods receivable into the cartridge barrels to dispense the components. The flexible piston rods are in the form of tightly coiled springs. Synchronous movement of the springs is enabled by securely fitting one end of the springs over respective stub shafts located on the power piston.

EP-A-0492413 discloses a device for mixing and dispensing multiple-component dental materials. The device includes a housing, a trough-shaped receptacle for two adjacent parallel cartridges which have a mixer head attached to their front ends, rigid pistons movably disposed in the cartridges, an electrical motor for driving the pistons, a mixer rotating shaft extending parallel to, and disposed between, the cartridges and having its front end engaging a mixer element rotatably supported within the mixer head, and an electrical motor for driving the shaft. The two pistons are rigidly interconnected at their back ends by a transverse member and are advanced in common by an electrical motor. In operation, a unit consisting of filled cartridges and a mixer head attached thereto is placed into the receptacle. The pistons are then slowly advanced within their respective cartridges so as to urge the two components into the mixer head. Simultaneous rotation of the mixer element causes the components to be mixed to form a ready-to-use substance which is forced out of a dispensing opening of the mixer head.

Such a device is similar to one of the Pentamix™ Mixing Units commercially available and manufactured by 3M ESPE AG (Seefeld, Germany). The Pentamix™ Mixing Unit is used to mix and dispense dental materials. This is particularly advantageous for dental impression materials, where a base paste and a catalyst paste are usually provided for mixing using a device operated by the user. In most cases, a cartridge having sections containing the prepackaged base and catalyst pastes is loaded into the mixing unit. The pastes are displaced by pistons out of their respective packages and into a mixing area, where they are dynamically or statically mixed.

US 2004/0262332 discloses a hand-held device for storing, mixing and dispensing a free flowing multi-component dental material. For driving the components in the cartridge of the device forward, a ram is provided in the form of a rigid piston rod which is slideable within the cartridge and can be pressed by hand in order to transmit pushing forces. The device is used primarily for storing, mixing and dispensing relatively small amounts of dental material, and the pushing forces provided by the ram can be up to 150 N. In order to reduce the overall length of the device, the ram can be provided as two separable parts, where the two parts are arranged adjacent to each other during storage and are assembled together to form a piston rod as ram for use. In this case, a guide is also provided in the device in order to reduce the risk of buckling when the ram is pressed into the cartridge.

### SUMMARY OF THE INVENTION

The present invention is specified in the attached claims.

The present invention is preferably directed to a mixing and dispensing device as used by the applicant with the trade name Pentamix™ and as also described above. Such a dispenser preferably comprises at least a first and a second material section or material compartment containing a first and a second component for the dental substance, respectively. It further preferably comprises a first and a second plunger advanced by a first and second force transmitting member for expelling the components from the material sections into a mixing area. The mixing area preferably comprises a dynamic mixer for automatically mixing the components to form the dental substance and for dispensing the mixture.

In contrast to a rigid force transmitting member as used in the Pentamix™ 2 Mixing Unit as described above, the force transmitting member of the invention is preferably foldable at least over a part over its length when retracted and unfoldable when extended. An unfolded (extended) part of the force transmitting member preferably forms a rigid, substantially straight structure and provides for transmission of a pushing force without requiring external guidance. Further, the force transmitting member is adapted for transmitting a pulling force when unfolded or folded (extended or retracted, respectively).

The term pushing force corresponds to a thrust generally along or parallel to the longitudinal axis or path of an extended part of the transmitting member. Preferably, the force transmitting member can be folded only two-dimensionally, and more preferably in only one direction away from the path defined by the extended state of the force transmitting member.

In a preferred embodiment, the force transmitting member is arranged in the device such that the extended part can be pushed, for example, to advance a plunger of the device in a direction toward the substance, e.g. to dispense substance into a mixing area.

In a preferred embodiment of the present invention, the mixing and dispensing device preferably comprises at least one force transmitting member adapted to a) transmit a pushing force in a direction toward the dental substance and a pulling force in the opposite direction and b) be gathered “non-linearly”, in the sense that it can be gathered, collected or accumulated, at least in part, spirally, in an angled, bent, coiled, looped, wound or folded configuration or any other non-linear fashion.

In an alternative embodiment, the force transmitting member is arranged that the extended part can be pushed, for example to advance a plunger in the opposite direction, e.g. to move it away from the substance.

In a further preferred embodiment of the invention, the mixing and dispensing device preferably comprises at least one force transmitting member adapted to a) transmit a pushing force in a direction away from the dental substance and a pulling force in the opposite direction and b) be gathered non-linearly.

Preferably, the force transmitting member comprises elements designed to prevent the force transmitting member from folding, buckling, bending or collapsing when the force transmitting member is pushed in its extended state. The force transmitting member is preferably configured to transmit pushing forces or thrust up to 10 kN. For example, pushing or thrust forces necessary for dispensing dental impression materials can be between 1 and 7 kN. The force transmitting member preferably is further adapted to transmit a pulling force of approximately 12 kN.

The force transmitting member further is configured to gather, collect or accumulate, e.g. to be bent, coiled, looped, wound or folded spirally, in an angled or similar manner. In this respect, the length of the device of the present invention with a maximally retracted force transmitting member may be less than twice the axial drive length or travel of the transmitting member and preferably less than 1.5 times the axial drive length. In many cases, the axial drive length is approximately the length of the material section. If the force transmitting member can be gathered non-linearly, a reduction in the overall size of the device can be achieved. This provides particular advantages in an area with limited space for storing the device.

Preferably, the force transmitting member comprises a series of foldably connected elements such as a so called push-pull chain designed such that folding of the force transmitting member is permitted when the force transmitting member is gathered non-linearly, and folding is not permitted when the force transmitting member is extended under linear thrust motion, e.g. when the force transmitting member is transmitting a pushing force along or parallel to the longitudinal axis of the material section. The elements can be so designed and linked such that folding or bending of the force transmitting member is permitted in only one direction when being gathered non-linearly, but when extended under linear thrust motion, folding or bending of the force transmitting member is not permitted and the linked elements form a rigid structure. For example, the force transmitting member may be in the form of a push-pull chain (e.g. a Framo® push-pull chain manufactured by Framo®-Fraiz Morat KG, Eisenbach, Germany). One further example of a push-pull chain of the type that can be used in this invention is the one disclosed in EP 936 378, the contents of which are incorporated by reference herein.

The device of the present invention also comprises at least one material section for receiving a dental substance. The material section can be in any suitable form. For example, the material section can be in the form of a compartment, chamber, cartridge, reservoir, or cylindrical groove, preferably cylindrical space, for receiving or accommodating the dental substance, material or material component. Preferably the device comprises two material chambers for receiving two components of the substance to be mixed and dispensed. Preferably, a material section is provided for each component of the dental substance or material to be dispensed. The at least one material section may also be an area for receiving a cartridge containing the substance(s) or components of the substance to be dispensed. The component or substance in the material or cartridge may also be pre-packaged in foil, a cylindrical tube or the like. Preferably, the force transmitting member is configured to extend the entire length of the material section in order to assure that the substance can be completely displaced from its container.

Preferably, the force transmitting member is adapted to transmit pushing or pulling force along or essentially parallel to the longitudinal axis of the respective material section when being extended along or essentially parallel to that axis. Preferably, the force transmitting member is adapted to gather non-linearly when retracted, such that the force transmitting member has a length in the direction of the material section when retracted at least in part that is less than the length of its maximum possible axial extension. Preferably, the length of the device is less than twice the length of the pre-packaged material components. In this respect, the length of the material section is approximately equal to the length of the pre-packaged component contained therein.

The device of the present invention preferably also comprises at least one displacement element associated with each of the at least one force transmitting member(s). Preferably, the displacement element is slideable within a corresponding material section for pushing the substance contained therein. Preferably, the displacement element is a plunger, plate or the like.

Preferably, the device comprises at least one guiding member for gathering or collecting the force transmitting member. The guiding member is preferably adapted to gather the force transmitting member spirally or in an angled configuration. The guiding member may also drive the force transmitting member for retracting or for extending. For example, the guiding member may be a sprocket, wheel (e.g., a deflection wheel) or reel which drives the force transmitting member and provides for gathering during retracting the force transmitting member. In this respect, the guiding member may serve to both, drive the force transmitting member and to guide it for folding. Preferably a guiding member is provided for each force transmitting member. Further the guiding members are preferably fixed on a common drive shaft which in turn is rotatably fixed at or connected with the housing of the device, for example.

The device may also comprise gear members, drive shafts and the like for driving the guiding member.

Preferably, the device of the present invention also comprises an actuation unit for actuating the force transmitting member in a forward or reverse direction, for example for extending and retracting, respectively, or vice versa. Preferably, the guiding members are driven by a common drive shaft which is in turn driven by the actuation unit. For example, the actuation unit may comprise an electrical actuation device such as an electrical motor. The actuation unit may also comprise a manual actuation device for activating the transmitting member thereby causing the transmitting member to move in either a forward or reverse direction. For example, such a manual actuation device can be in the form of a handle, ratchet, hand wheel and/or manipulating device used to advance or retract the transmitting member.

The device of the present invention may also comprise a mixing area for receiving and mixing or merging the dental substances. Preferably, the mixing area comprises a static mixer or dynamic mixer, and either can be provided in any suitable form. For example, the static mixer may be a spiral-shaped element providing passive mixing of the substances as the substances are driven through the spiral element. The dynamic mixer may, for example, be a spiral element or a rotor with mixing paddles rotationally driven by a shaft associated with the actuation unit. The mixing area can be in any suitable form. For example, the mixing area can be a mixer nozzle.

The device of the present invention may also comprise an indicator assembly for enabling the user to estimate the amount of material remaining or present in the material section or cartridge. In particular, the indicator assembly indicates the position of the force transmitting member(s) and/or displacement element(s) within the device. The indicator assembly may be in any suitable form for enabling a user to evaluate the position of the force transmitting member(s) and/or displacement element(s). Preferably, the indicator assembly includes an element and/or band associated with or attached to the force transmitting member and/or displacement element and an indicator associated with the element and/or band. Preferably, the indicator is visible to the user through a window or transparent surface of the device.

In a first aspect of the present invention, the dispensing device comprises at least one force transmitting member adapted to transmit pushing force in a direction toward the dental substance and to be gathered non-linearly. The force transmitting member is caused to unfold and extend (i.e., be arranged elongated or extended) substantially linearly, when it is advanced forward, i.e. when it is operated to push the substance forward to cause dispensing of the substance or to urge the substance into a mixing area. In this aspect of the invention, the transmitting member transmits pushing force in the direction of the substance in order to displace the substance in a forward direction.

In a second aspect of the present invention, the force transmitting member is adapted to transmit pushing force in a direction opposite the substance and to be gathered non-linearly. In this aspect of the invention, the force transmitting member transmits pulling force in order to cause displacement of the substance in a forward direction.

In the second aspect of the invention, the force transmitting member is preferably associated with a displacement element which is slideable within a material section and is suitable for pushing the substance in the material section. Preferably, the displacement element comprises side elements which can be linked to the force transmitting member. Preferably, a displacement element is provided for each material section. The material section may comprise at least one slot along the side of the material section for receiving at least one side element of the displacement element.

The device of the present invention is preferably a multiple-component dispenser which provides both mixing and dispensing of dental substances, for example dental impression materials.

The device of the present invention preferably is a table-top device.

The dispensing device of the present invention may be used to dispense a wide variety of flowable dental substances which are suitable for dispensing by displacement as provided for by the present invention. For example, such substances may include dental polyether impression materials, dental silicone impression materials, putty and the like or components thereof.

The present invention is also directed to a system for dispensing highly viscous dental materials, the system comprising the device of the present invention and at least one cartridge placeable into the material section of the device where the cartridge contains a dental material or components thereof. Preferably, the system comprises an actuation unit for actuating the at least one force transmitting member of the device. The actuation unit preferably comprises at least one guiding member or drive train for driving or moving and/or guiding the at least one force transmitting member of the device. Preferably, the system comprises a mixing area for mixing the dental material from the components expelled from the cartridge. The mixing area may also comprise an area for first merging and subsequently mixing of the components.

The present invention is also directed to methods for dispensing flowable dental materials using the device of the present invention, the method comprising providing at least one force transmitting member adapted to a) transmit a pushing force in a direction toward or opposite the dental material and b) be gathered non-linearly. Preferred features of the device explained above or below are also relevant preferred features of the method according to the present invention.

It is an advantage of the present invention to provide improved dispensing devices, systems and methods, which enable synchronous advancement of the members for driving the materials without the need for connecting and guiding the driving members using cross bars, linear guides and the like.

It is also an advantage of the present invention to provide improved devices, systems and methods enabling mixing and dispensing of material components at exact mixing ratios. It is also an advantage of the present invention to provide a dispensing device having an improved driving mechanism especially suitable for expelling components of highly viscous dental materials or multiple components of different viscosities.

It is also an advantage of the present invention to provide improved devices and systems for mixing and dispensing dental impression materials, which can be, in terms of size, economic in design.

It is also an advantage of the present invention to provide a significant reduction in the overall size of the dispensing device and to provide a reliable device which further preferably may even have an improved strength or rigidity.

Although particularly suitable for dispensing dental impression materials, the devices, systems and methods of the present invention are not restricted to dental materials and may be used for any suitable multi-component material.

### BRIEF DESCRIPTION OF THE DRAWINGS

Preferred embodiments of the present invention will be further described by the following description and drawings:

FIG. 1 is a perspective partial view of a prior art device.

FIG. 2 is a longitudinal side view of a part of a prior art device.

FIG. 3 is a perspective partial view of an embodiment of the device according to the present invention.

FIG. 4 is a rear perspective partial view of the embodiment of the invention shown in FIG. 3.

FIG. 5 is a longitudinal side view of the part shown in FIG. 3.

FIG. 6 is a perspective partial view of another embodiment of the device according to the present invention.

FIG. 7 is a rear perspective partial view of the embodiment of the invention shown in FIG. 6.

FIG. 8 is a longitudinal side partial view of the embodiment of the shown in FIG. 6.

FIG. 9 is a rear perspective partial view of a drive assembly according to the present invention.

FIG. 10 is a front perspective partial view of the drive assembly of FIG. 9.

FIG. 11 is a schematic view showing an indicator assembly according to the present invention.

### DETAILED DESCRIPTION

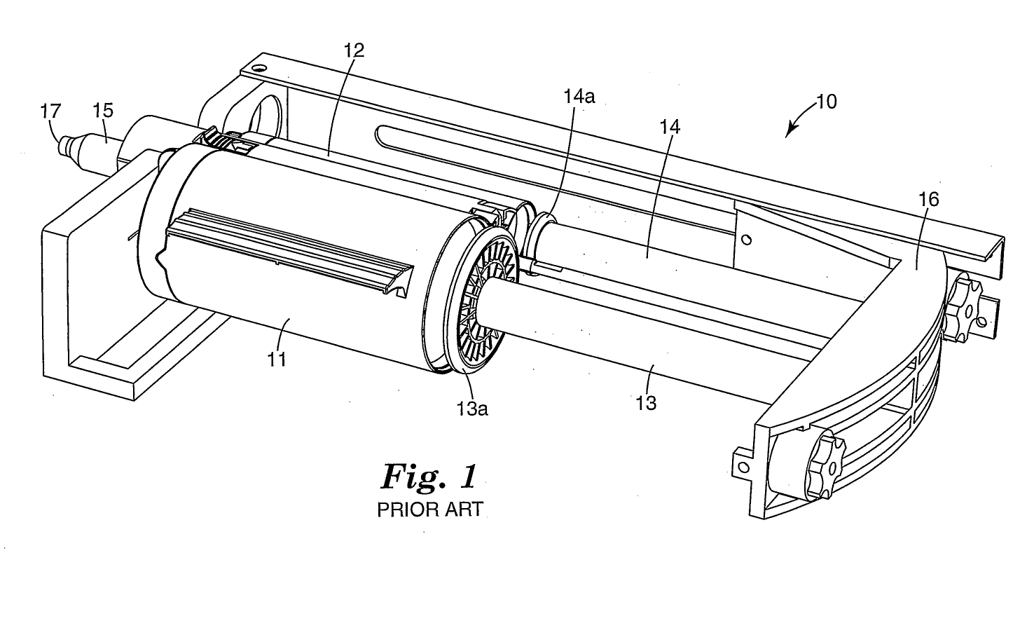

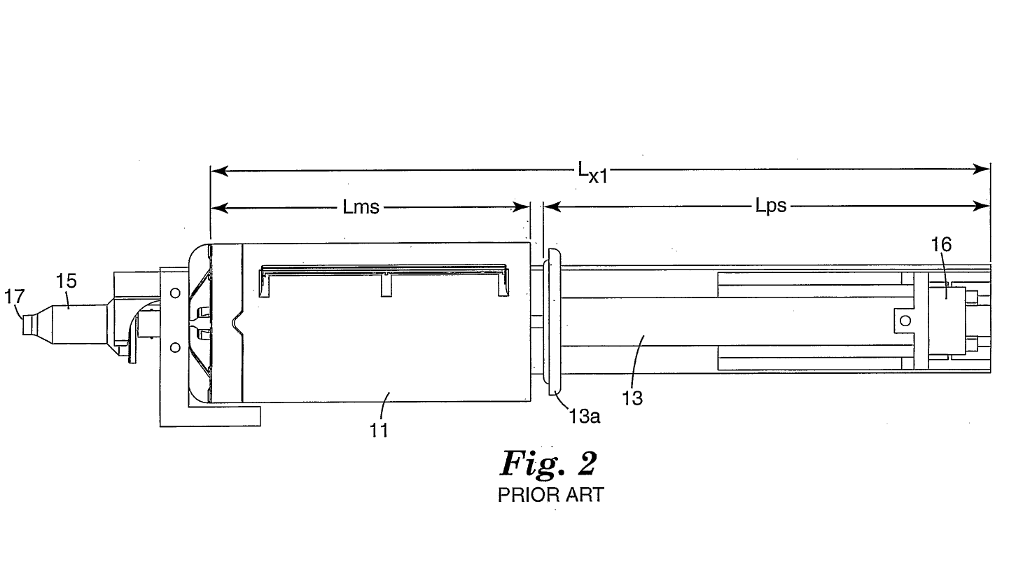

FIGS. 1 and 2 show partial views of a prior art dispensing device 10 for mixing and dispensing multiple-component dental substances. Such a device 10 is similar to one of the Pentamix™ mixing units commercially available and manufactured by 3M-ESPE AG, Seefeld, Germany. This dispensing device 10 essentially comprises two adjacent parallel sections 11, 12 suitable for containing substances, a drive unit comprising two plungers 13, 14 serving as force transmitting members and movably disposed within respective material sections 11, 12 for displacing the substances contained in sections 11, 12 in a forward direction, an electrical motor (not shown) for driving the plungers 13, 14 and a mixer nozzle 15 in fluid communication with the front ends of material sections 11, 12. The plungers 13, 14 are rigidly interconnected at their back ends by a transverse member 16 for ensuring that the plungers 13, 14 are driven simultaneously into material sections 11, 12. Each plunger 13, 14 comprises a plunger head and plunger rod.

In operation, a cartridge unit having material sections 11, 12, each containing a pre-packaged substance, is placed into the dispensing device, thus being located with regard to the assembly 10 as shown. The plungers 13, 14 are designed such that their plunger heads 13a, 14a may abut the back ends of the packaged substances. As shown in FIG. 1, plunger head 13a is dimensioned to fit within material sections 11 having a diameter slightly larger than that of plunger head 13a. The plungers are made rigid in order to ensure that sufficient thrust force is applied in the longitudinal axial direction. As plungers 13, 14 are moved forward within material sections 11, 12, the packaging of the substances is opened. The plungers 13, 14 are slowly advanced into respective material sections 11, 12 so as to urge the two substances in material sections 11, 12 into the mixer nozzle 15. The substances are mixed in the mixer nozzle 15 to form a ready-to-use substance which is forced out of a dispenser output 17 of the mixer nozzle 15. After the desired amount has been dispensed, the device 10 is switched off.

In order to assure that the packaged substances can be completely pressed out by the plungers, plungers 13, 14 are designed such that they are slideable along the entire length of respective material sections 11, 12 containing the packaged substances. To this end, the plunger including plunger head and rod is generally designed to have a length that is at least equal to or greater than the length of the respective material section containing the substance. When the plungers 13, 14 are not engaged into material sections 11, 12, they are stored in a fully retracted position as shown in FIGS. 1 and 2. The length of the storage area Lps for the fully retracted plunger corresponds at least to the length of the plunger, which preferably corresponds to the length Lms of material section. The entire length Lₓ₁ of such a device corresponds at least to Lms plus Lps. In this respect, the storage area for the plunger has to be accommodated longitudinally and thus adds to the length or size of the device.

The present invention provides alternative drive mechanisms for displacing substances forward whereby the storage area Lps for the force transmitting member, particularly along the longitudinal axis, can be significantly reduced.

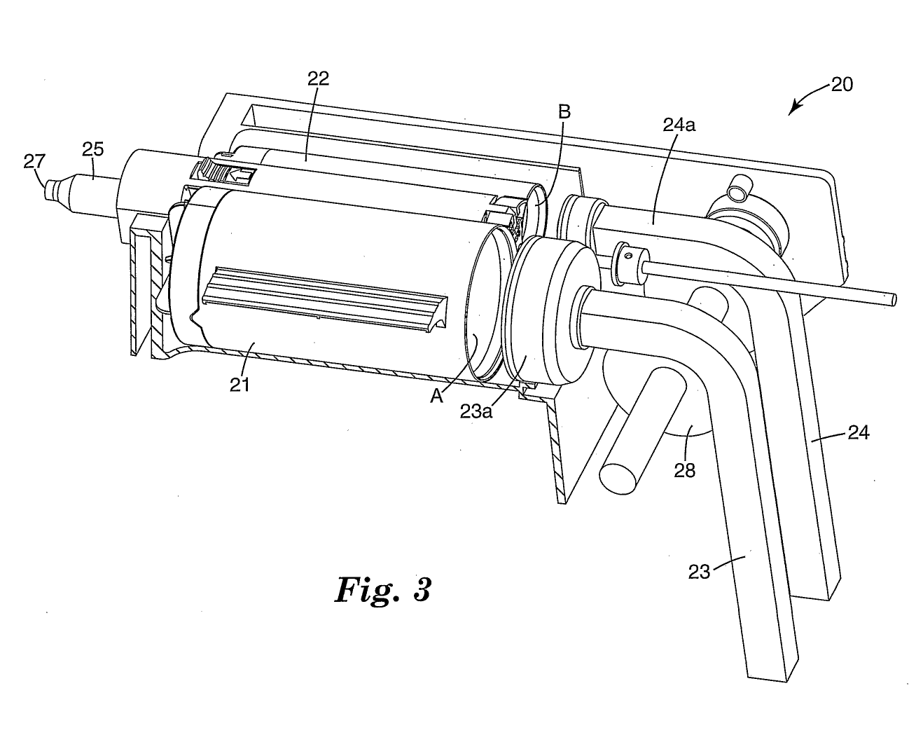

FIGS. 3-5 illustrate an embodiment of a dispensing device 20 according to the first aspect of the present invention. This embodiment of the present invention, as shown in FIGS. 3-5, relates to a dispensing device 20 for mixing and dispensing a two-component dental substance.

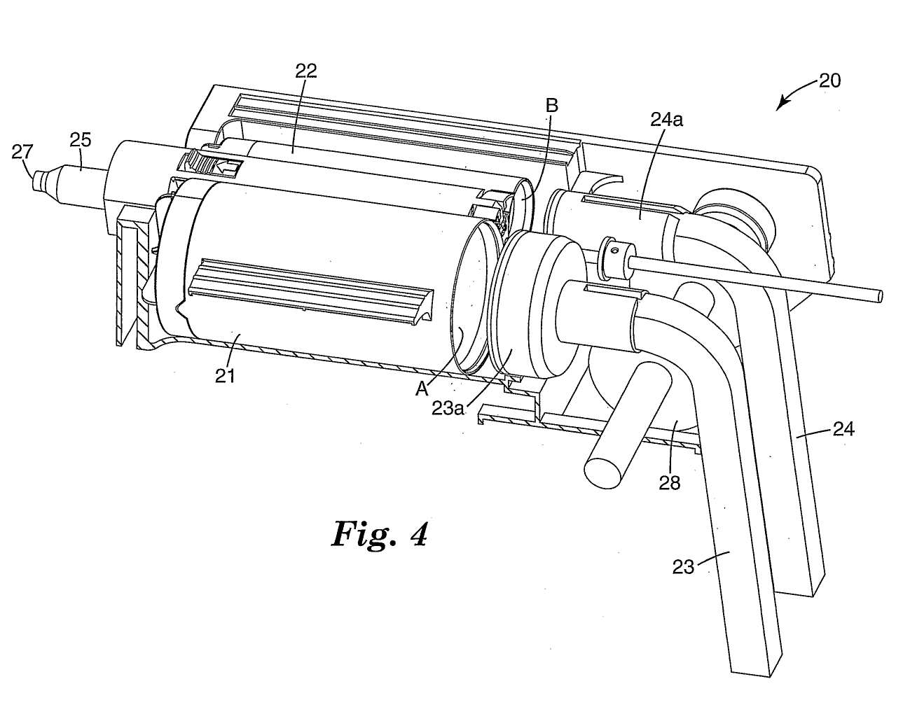

Referring to FIGS. 3 and 4, the dispensing device 20 of this embodiment of the invention comprises two adjacent parallel material sections 21, 22 suitable for containing respectively substances A and B, two force transmitting members 23, 24 movably disposed within respective material sections 21, 22 for displacing substances A, B in a forward direction and a mixer nozzle 25 in fluid communication with the front ends of material sections 21, 22.

The force transmitting members 23, 24 of the present invention transmit linear thrust force along the longitudinal axis of the respective material sections 21, 22 when they are extended along that axis and, at the same time, are adapted to gather non-linearly, as shown in FIGS. 3 and 4. The force transmitting member can also be adapted to transmit pushing or pulling force in a transverse direction or any other suitable direction to displace substance, material or components thereof. The force transmitting members 23, 24 of this embodiment are adapted to transmit pushing force in a direction toward the substance in order to cause forward displacement of the substance.

When extended, the force transmitting member 23, 24 forms a structure sufficiently rigid to transmit force against the substance A, B contained in the material section 21, 22 preferably to displace the material in the direction of an opening. Thus, the substance can be compressed in a longitudinal, transverse or any other direction of the device, material section and/or material cartridge so that the material is appropriately displaced, preferably in the direction of an opening in the device, material section and/or material cartridge. Also, the transmitting member 23, 24 is configured to extend the entire length of the material section 21, 22. In this respect, reliable and accurate dispensing of the substances can be provided. Preferably, the transmitting member 23, 24 comprises structured elements designed to prevent the transmitting member from bending or collapsing during linear thrust motion. The transmitting member 23, 24 is preferably configured to realize thrust forces up to 10 kN.

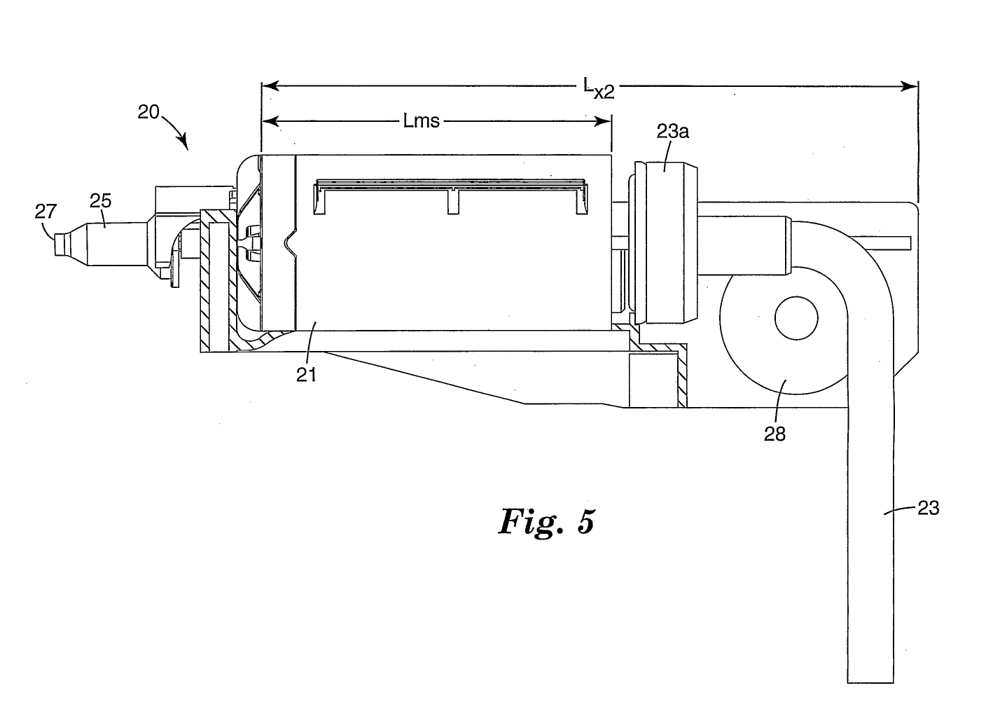

When retracted, the force transmitting member 23, 24 is configured to be gathered by, for example, being wound up, looped or folded. This enables a reduction in storage space for the force transmitting member, and thus for the overall device. The device 20 further comprises a guiding member 28 for gathering and driving the transmitting member 23, 24. In this respect, the length Lx₂ (shown in FIG. 5) of the device 20 with maximally retracted transmitting members 23, 24, can be less than twice the axial drive length of the transmitting member (i.e., the longitudinal length Lms of the material section), preferably less than 1.5 times the axial drive length. Lms, as indicated in FIGS. 2, 5 and 8, corresponds to the length of the section containing the material or substance. The length Lms of the material section corresponds to slightly more than the length of the packaged substance contained therein.

In operation, a cartridge unit having material sections 21, 22, each containing a packaged substance, is placed into the dispensing device 20. When activated, the transmitting members 23, 24 are advanced forward in a direction toward the substance. FIGS. 3 and 4 show the transmitting members 23, 24 in fully retracted positions at the rear ends of the respective material sections 21, 22. The transmitting members 23, 24 are caused to unfold and extend along the longitudinal axis of material sections 21, 22. Once extended and advanced within the material sections, the transmitting members 23, 24 push the substances A, B forward in their material sections 21, 22 so as to urge substances A, B into the mixer nozzle 25. The substances are mixed in the mixer nozzle 25 to form a ready-to-use substance which is forced out of a dispenser output 27 of the mixer nozzle 25. After the desired amount has been dispensed, the device 20 is switched off thereby deactivating the force transmitting members and immediately preventing further dispensing of the ready-to-use substance. When the substances A, B are completely dispensed or a different substance is to be used, the transmitting members 23, 24 can be retracted toward the rear ends of their respective material sections 21, 22 in order to allow new packages of substances to be introduced into the material sections 21, 22.

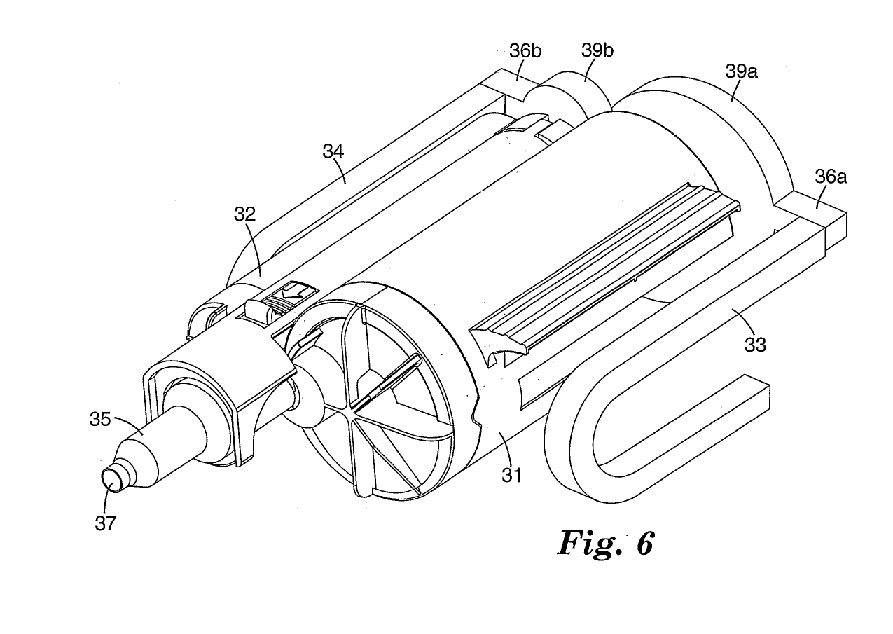

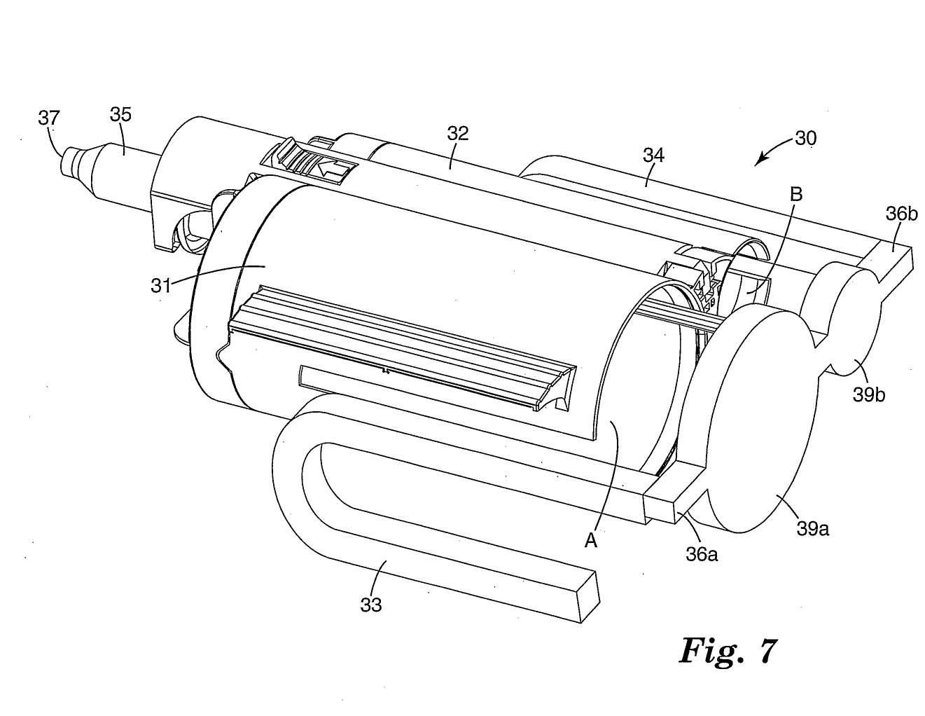

FIGS. 6-8 illustrate an embodiment of a dispensing device 30 according to the second aspect of the present invention. This embodiment of the present invention relates to a dispensing device 30 for mixing and dispensing a two-component substance.

The dispensing device 30 comprises two adjacent parallel sections 31 and 32 suitable for holding respectively packaged substances A and B, two force transmitting members 33 and 34 being associated respectively with plungers 39a and 39b. The plungers 39a and 39b are movably disposed within respective material sections 31 and 32 and serve to displace substances A and B in a forward direction. The plungers 39a, 39b could also be interconnected in order to assure simultaneous movement of the plungers.

The force transmitting members 33, 34 of this embodiment of the invention are adapted to transmit pushing force in a direction opposite the substance. In order to cause forward displacement of substances A, B, force transmitting members 33, 34 are adapted to transmit pulling force in a direction toward the substance. The force transmitting members 33, 34 are also adapted to be gathered non-linearly as can be seen in FIGS. 6-8.

Referring to FIGS. 6-8, at fully retracted positions, plungers 39a, 39b are located at the rear end of respective material sections 31, 32 and the force transmitting members 33, 34 are extended preferably along the entire length of respective material sections 31, 32. As guiding members drive force transmitting members 33, 34 in a direction toward the substance, transmitting members 33, 34 pull side elements 36a, 36b of plungers 39a, 39b in a forward direction. Preferably, transmitting member 33, 34 comprises structured elements designed to prevent the transmitting member 33, 34 from bending or collapsing while being extended under linear thrust motion. Preferably, transmitting member 33, 34 is configured to move in a direction opposite or toward the substance thereby transmitting pushing or pulling forces onto plunger 39a, 39b.

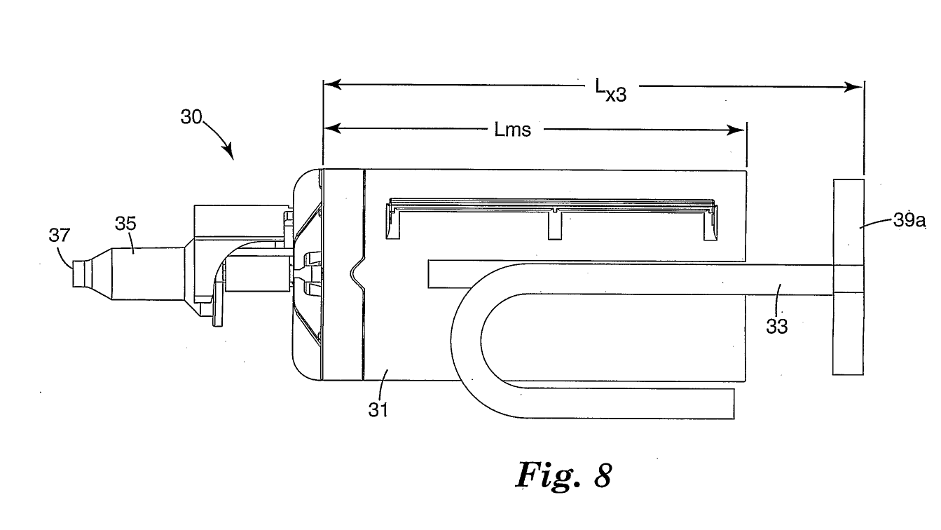

When retracted, the force transmitting member 33, 34 is configured to be gathered non-linearly as shown in FIGS. 6-8. This enables a reduction in storage space for the transmitting member when compared with conventional devices. Preferably, a guiding member guides the force transmitting member 33, 34 as it is being gathered. In this respect, the length of the device 30 with maximally extended force transmitting members 33, 34 as shown in FIG. 8 can be less than twice the length of the axial drive length of the force transmitting member (i.e. the longitudinal length Lms of the material section), preferably less than 1.5 times the axial drive length. The length Lms of the material section refers to approximately the length of the packaged substance contained therein.

While being driven forward in operation, the transmitting members 33, 34 are caused to gather non-linearly and, at the same time, plungers 39a, 39b are pulled forward by the transmitting members 33, 34. The plungers 39a, 39b are pulled forward within their respective material sections 31, 32 so as to urge substances A, B into mixer nozzle 35. The substances A, B are mixed in the mixer nozzle 35 to form a ready-to-use substance which is forced out of a dispenser output 37 of the mixer nozzle 35. After the desired amount has been dispensed, the device 30 is switched off thereby deactivating movement of the force transmitting members and immediately preventing further dispensing of the ready-to-use substance.

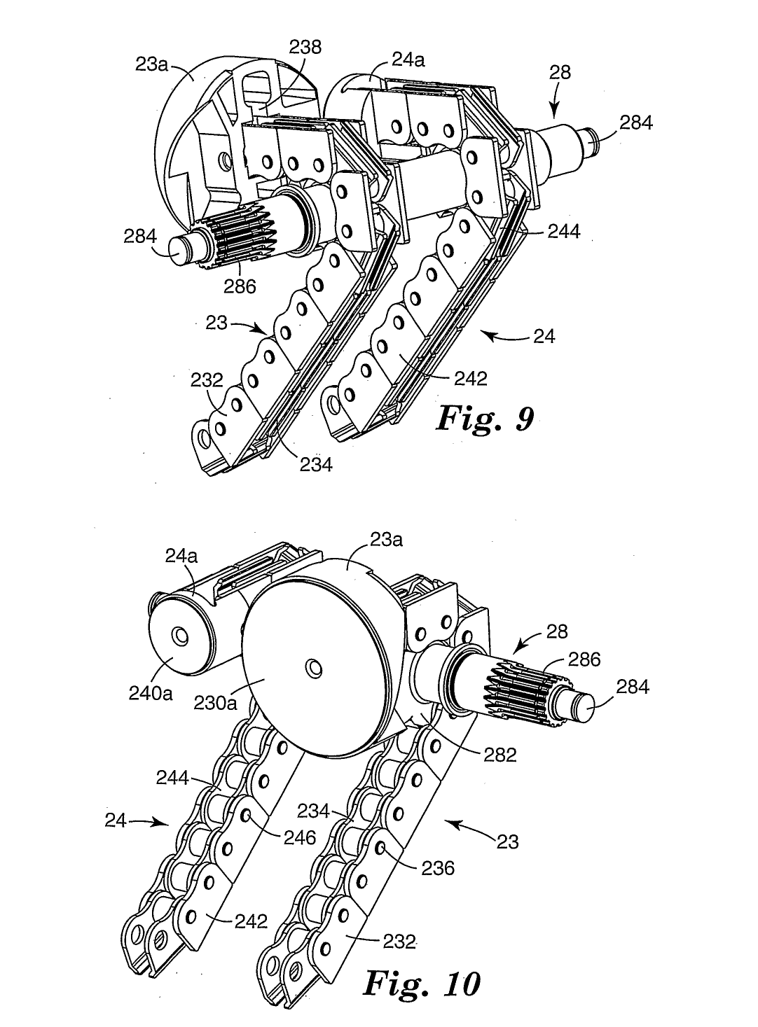

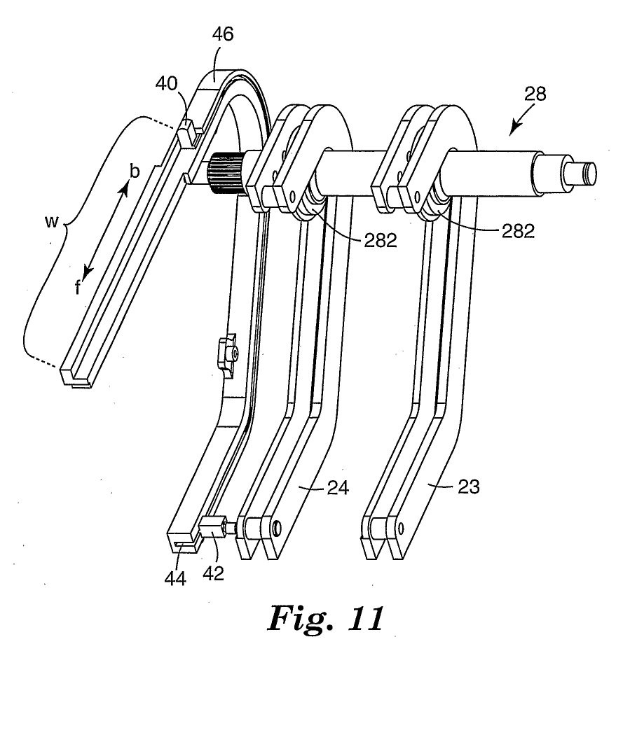

FIGS. 9 and 10 illustrate a preferred embodiment of a drive assembly for use in the devices of the present invention. In this embodiment, the force transmitting members shown in FIGS. 3 to 8 are push-pull chains 23 and 24. Each push-pull chain 23, 24 comprises a plurality of elements 232, 242, 234, 244 which are pivotably linked by connecting elements 236, 246. Each push-pull chain 23, 24 has a plunger 23a, 24a connected at a front end 238 of the push-pull chain 23, 24. As shown, plungers 23a and 24a have different cross-sectional areas for considering mixing ratios different from 1:1. As previously discussed, components for dental impression materials are often mixed at a ratio of 1:2 (or, in some cases 1:5).

The push-pull chains 23, 24 are adapted to be arranged extended, such that the extended parts of push-pull chains 23, 24 may transmit a pushing force generally along or parallel to the longitudinal axis or path of the extended parts of the push-pull chains 23, 24. Push-pull chains 23, 24 are able to transmit pushing forces preferably up to 7 kN and most preferably up to 10 kN. The extended parts of push-pull chains 23, 24 are adapted to form so rigidly stable structures while transmitting a push force along the path of the extended parts of the push-pull chains 23, 24, that linear guidance (for example, by using guide channels, linear bearings and the like) are not necessary.

As shown, the push-pull chains 23, 24 can be arranged folded or bent at least over a section of their length relative to the extended parts. Moreover, push-pull chains 23, 24 are adapted to be gathered non-linearly. Preferably, push-pull chains 23, 24 can be folded two-dimensionally in only one direction away from the path defined by the extended state of the push-pull chains 23, 24. The paths defined by the extended state of the push-pull chains 23, 24 are generally along the length (Lms) of the material sections as shown in FIG. 5.

A guiding member or assembly 28 can be provided, as shown in FIGS. 3 to 10, for driving the push-pull chain 23, 24 and guiding push-pull chain 23, 24 in folded, bent, looped or wound configuration. In this embodiment, the guiding assembly 28 comprises two deflection wheels 282 associated with a common drive shaft 284. Push-pull chains 23, 24 are driven using the common drive shaft 284. With this arrangement, simultaneous movement of driving members can be ensured and, the effort of connecting and guiding as suggested in the afore-described prior art can be eliminated.

Also, the drive assembly of the present invention can be adapted to provide an exact advancing ratio for the push-pull chains. Push-pull chains 23, 24 can be adapted to have different sized gear links 234, 244. Gear links 234, 244 can be driven by different sized teeth of deflection wheels or gears 282 associated respectively with push-pull chains 23, 24. Gears 282 are attached to a common draft shaft 284, and thus the push-pull chains 23, 24 are driven by same drive shaft 284. Preferably, as push-pull chain 23 advances one unit length per revolution of its gear, push-pull chain 24 advances only a portion, e.g. ⅕^{th}, of a unit length per revolution of its gear because it has smaller teeth or a smaller diameter gear. With this arrangement, various mixing ratios can also be achieved without using different cross-section areas for the plungers.

The drive shaft 284 can be provided with a teeth area 286 for being supported or driven by rotary bearings, preferably ball bearings. This provides several advantages. Rotary bearings can be implemented more economically since they are generally smaller, weigh less and cost less than linear bearings for example. Also, rotary bearings are more effective with regard to stiffness and stability than linear bearings.

The drive assemblies of the present invention are not limited to the use of only two push-pull chains. Preferably, a push-pull chain is provided for each material component.

The devices and systems of the present invention may also comprise an indicator assembly for enabling the user to estimate the quantity of material present or remaining in the cartridge or material chamber.

As shown in FIG. 11, the indicator assembly preferably comprises a mount 46 having a groove or channel 44, wherein a band (not shown) can be located. Preferably, the band has an indicator 40 attached at one end and a connection element 42 attached at the other end. The connection element is attached to the push pull chain 24. The indicator 40 is made visible to the user by providing a transparent surface or window W in the housing of the device (not shown). As the push-pull chain 23, 24 is advanced toward the substance or material, the indicator 40 moves in direction f shown in FIG. 11. As the push-pull chain 23, 24, is retracted or moved in a direction opposite the substance, the indicator 40 moves in direction b shown in FIG. 11. The position shown in FIG. 11 of the indicator 40 represents a position where the push-pull chains 23, 24 are considered to be maximally retracted.

In operation, the device having push-pull chains 23, 24 as force transmitting members operates in a similar manner as described for the first and second aspects of the invention.

The various embodiments presented in the specification are used for the sake of description and clarification of the invention, and thus should not be interpreted as limiting the scope of the invention as such. Features of the different embodiments may be interchanged whenever appropriate. Moreover, the present invention is realized by the features of the claims and any obvious modifications thereof.

1. A device for mixing and dispensing at least one flowable dental substance, comprising
at least one force transmitting member comprising a push-pull chain adapted to a) transmit a pushing force in a direction toward the dental substance and a pulling force in the opposite direction and b) be gathered non-linearly.

2. A device for mixing and dispensing at least one flowable dental substance, comprising
at least one force transmitting member adapted to a) transmit a pushing force in a direction away from the dental substance and a pulling force in the opposite direction and b) be gathered non-linearly.

3. The device of claim 1, further comprising
at least one material section for receiving at least a component of the dental substance; and
wherein the force transmitting member is adapted for transmitting force against the dental substance to displace it in the direction of an opening of the material section.

4. The device of claim 3, wherein the force transmitting member is configured to transmit pushing and pulling force(s) parallel to the longitudinal axis of the material section.

5. The device of claim 3, wherein the force transmitting member is adapted to gather non-linearly when retracted such that the force transmitting member has a length in the direction of the material section that is less than the length of its maximum possible axial extension.

6. The device of claim 2, further comprising at least one displacement element associated with each of the force transmitting members, the displacement element being slideable within the corresponding material section for pushing the dental substance contained therein.

7. The device of claim 6, wherein the displacement element is a plunger.

8. The device of claim 6, wherein the force transmitting member is configured to transmit a pushing force onto the displacement element thereby causing the displacement element to move in a direction toward the dental substance in the material section.

9. The device of claim 1, wherein the force transmitting member comprises a series of foldably connected elements designed such that folding of the force transmitting member is permitted when the force transmitting member is gather non-linearly, and folding is not permitted when the force transmitting member is extended under linear thrust motion.

10. The device of claim 1, wherein the force transmitting member is adapted to transmit substantially equal forces in a forward and a reverse direction.

11. The device of claim 1, wherein the force transmitting member of the present invention is adapted to be arranged a) extended or b) folded or bent at least over a section of its length relative to the extended state.

12. The device of claim 1, wherein the force transmitting member can be folded two-dimensionally in only one direction away from the path defined by the extended state of the force transmitting member.

13. The device of claim 1, further comprising at least one guiding member for gathering the at least one force transmitting member.

14. The device of claim 13, wherein the guiding member serves to drive the at least one force transmitting member and to guide the force transmitting member for folding or bending.

15. The device of claim 14, wherein the guiding member is a drive shaft comprising at least one deflection wheel for each force transmitting member, such that the force transmitting members are driven simultaneously by the drive shaft.

16. The device of claim 13, wherein the guiding member is adapted to cause the force transmitting member to be gathered spirally or in an angled configuration.

17. The device of claim 1, wherein the device comprising at least two material sections and a mixing area in fluid communication with front ends of the material sections.

18. The device of claim 1, wherein the device comprises an actuation unit, preferably an electrical actuation device.

19. (canceled)

20. The device of claim 1, further comprising:
at least one material section for receiving a substance; and
wherein the at least one force transmitting member is adapted to transmit force along or essentially parallel to a longitudinal axis of the at least one material section thereby causing displacement of the substance in a forward direction and is adapted to gather non-linearly when retracted such that the length (Lx₂, Lx₃) of the device with the at least one force transmitting member being fully retracted is less than twice the length (Lms) of the at least one material section.

21. The device of claim 20, wherein the axial drive length of the force transmitting member is approximately equal to the length (Lms) of the material section.

22. The device of claim 20, wherein the length (Lx₂, Lx₃) of the device with the at least one force transmitting member being fully retracted is less than 1.5 times the length (Lms) of the at least one material section.

23. The device of claim 1, wherein the device is a hand-held device.

24. The device of claim 1, wherein the device is a table-top device.

25. A system for dispensing highly viscous dental materials, comprising:
a device according to claim 1; and
at least one dispensing cartridge placeable into a material section of the device and containing a dental material or a component thereof.

26. The system of claim 25, comprising an actuation unit for actuating the at least one force transmitting member of the device.

27. The system of claim 26, wherein the actuation unit comprises at least one drive train for moving and/or guiding the at least one force transmitting member of the device.

28. The system of claim 25, comprising a mixing area for mixing dental material components when the components are expelled from the cartridge.

29. A method for mixing and dispensing flowable dental substances using the device of claim 1, the method comprising:
providing at least one force transmitting member adapted to a) transmit a pushing force in a direction toward or away from the substance and a pulling force in the opposite direction and b) be gathered non-linearly.
